(19) United States
(12) Patent Application Publication
(10) Pub. No.: US 2025/0078495 A1
(43) Pub. Date: Mar. 6, 2025

(54) PERFORMING A COMPUTER VISION TASK

(71) Applicant: Samsung Electronics Co., Ltd., Suwon-si (KR)

(72) Inventors: Umberto MICHIELI, Staines (GB); Mete OZAY, Staines (GB); Jijoong MOON, Suwon-si (KR); Daehyun KIM, Suwon-si (KR); Elena CAMUFFO, Staines (GB)

(21) Appl. No.: 18/933,406

(22) Filed: Oct. 31, 2024

Related U.S. Application Data
(63) Continuation of application No. PCT/IB2024/057240, filed on Jul. 26, 2024.

(30) Foreign Application Priority Data
Sep. 5, 2023 (GB) 2313525.4
Apr. 10, 2024 (GB) 2405097.3

(51) Int. Cl. G06V 10/98; G06V 10/774; G06V 10/778; G06V 10/82

(52) U.S. Cl. CPC G06V 10/993; G06V 10/774; G06V 10/778; G06V 10/82

(57) ABSTRACT

The present disclosure relates to a computer-implemented method of performing a computer vision task. The computer-implemented method comprises: receiving a corrupted image from a camera; estimating a corruption type of the corrupted image using a corruption identification module; obtaining normalisation parameters associated with the estimated corruption type; updating a computer vision model, trained to perform the task, by replacing normalisation parameters of the computer vision model with the obtained normalisation parameters; and performing the task using the updated computer vision model.

### CROSS-REFERENCE TO RELATED APPLICATION(S)

This application is a continuation application, claiming priority under § 365(c), of an International application No. PCT/IB2024/057240, filed on Jul. 26, 2024, which is based on and claims the benefit of a United Kingdom patent application number 2313525.4, filed on Sep. 5, 2023, in the United Kingdom Intellectual Property Office, and of a United Kingdom patent application number 2405097.3, filed on Apr. 10, 2024, in the United Kingdom Intellectual Property Office, the disclosure of each of which is incorporated by reference herein in its entirety.

### BACKGROUND

### 1. Field

The present application generally relates to performing a computer vision task.

### 2. Description of Related Art

Developing a reliable vision system is a fundamental challenge for robotic technologies (e.g., indoor service robots and outdoor autonomous robots) which can ensure reliable navigation even in challenging environments such as adverse weather conditions (e.g., fog, rain), poor lighting conditions (e.g., over/under exposure) or sensor degradation (e.g., blurring, noise), and can guarantee high performance in safety-critical functions. Current solutions proposed to improve model robustness usually rely on generic data augmentation techniques or employ costly test-time adaptation methods. In addition, most approaches focus on addressing a single vision task (typically, image recognition) utilising synthetic data.

It is an object of the present invention to improve on the prior art.

### SUMMARY

According to an embodiment, a method for controlling an electronic apparatus for performing a computer vision task, the method may include receiving a corrupted image from a camera, identifying a corruption type of the corrupted image using a corruption identification module, obtaining normalisation parameters associated with the estimated corruption type from a codebook, updating a computer vision model, trained to perform the task, by replacing normalisation parameters of the computer vision model with the obtained normalisation parameters, and performing the computer vision task using the updated computer vision model.

The corruption identification module may include a fast Fourier transform, FFT, model. The identifying the corruption type of the corrupted image using a corruption identification model may include extracting features from the corrupted image, retaining only features occurring with a frequency above a frequency threshold using the FFT model, determining a probability that the image in input is affected by a corruption type associated with the retained features, which is a corruption type based on a distribution of distances between the retained features and pretrained prototypical features of a known set of corruption types, and identifying the corruption type by selecting the corruption type with the highest probability.

The distribution of distances may be a distribution of Euclidian, L2, distances.

The corruption identification module may include a machine learning model trained to estimate a corruption type using a corrupted image. The identifying the corruption type of the corrupted image using a corruption identification module may include inputting the corrupted image to the machine learning model to estimate the corruption type from the corrupted image.

The machine learning model may a deep neural network model.

The computer vision model may be a neural network model. The normalisation parameters may include at least one of batch normalisation, BatchNorm, parameters or layer normalisation, LayerNorm, parameters.

The neural network model may be a convolutional neural network model.

The computer vision task may be a computer vision task selected from a list of computer vision tasks including object detection, object recognition, semantic segmentation.

The method further comprising generating the codebook by providing a pre-trained computer vision model and a training data set, wherein the training data set comprises, for each corruption type of a plurality of corruption types, a plurality of corrupted images and corresponding labels associated with the computer-vision task the model has been trained to perform, re-training the pretrained computer vision model, for each corruption type, using the plurality of corrupted images and corresponding labels by updating only normalisation layers of the pretrained computer vision model, extracting the normalisation layers of the re-trained computer vision model for each corruption type, and generating the codebook to associate each recognizable corruption type to the corresponding normalisation layers parameters.

The normalisation layers may include at least one of batch normalisation, BatchNorm, layers and layer normalisation, LayerNorm, layers.

The method may include generating the codebook by: providing a pretrained computer vision model, corrupted images, and corresponding corruption type labels estimated by the corruption identification module, updating normalisation layers of the pre-trained computer vision model based on the corrupted images and the corresponding corruption type labels using a test-time adaptation algorithm, extracting the updated normalisation layers for each estimated corruption type, and generating a codebook to associate each recognizable corruption type to the corresponding normalisation layers parameters.

According to an embodiment, an electronic apparatus for performing a computer vision task may include a memory and at least one processor connected the memory, wherein the at least one processor configured to receive a corrupted image from a camera, identify a corruption type of the corrupted image using a corruption identification module, obtain normalisation parameters associated with the estimated corruption type from a codebook, update a computer vision model, trained to perform the task, by replacing normalisation parameters of the computer vision model with the obtained normalisation parameters, and perform the computer vision task using the updated computer vision model.

The corruption identification module may include a fast Fourier transform, FFT, model. The at least one processor may extract features from the corrupted image, retain only features occurring with a frequency above a frequency threshold using the FFT model, determine a probability that the image in input is affected by a corruption type associated with the retained features, which is a corruption type based on a distribution of distances between the retained features and pretrained prototypical features of a known set of corruption types, and identify the corruption type by selecting the corruption type with the highest probability.

The distribution of distances may be a distribution of Euclidian, L2, distances.

The corruption identification module may include a machine learning model trained to estimate a corruption type using a corrupted image. The at least one processor may input the corrupted image to the machine learning model to estimate the corruption type from the corrupted image.

### BRIEF DESCRIPTION OF THE DRAWINGS

Implementations of the present techniques will now be described, by way of example only, with reference to the accompanying drawings, in which:

FIG. 1 shows a robot vacuum cleaner, RVC, operating in a room, according to at least one embodiment;

FIG. 2 shows a block diagram of a computer vision system run on the RVC of FIG. 1, according to at least one embodiment;

FIG. 3 shows a flow chart of training and a flow chart of inference to determine a corruption type of an input image, which forms part of the computer vision system of FIG. 2;

FIG. 4 shows graphs representing a clustering algorithm applied to a features extraction module associated with the flow chart from FIG. 3;

FIG. 5 shows analytics graphs when operating the flow chart from FIG. 3;

FIG. 6 shows a flow chart summarising the method from FIG. 3 used to predict a label of a corruption type and use it to perform a computer vision task;

FIG. 7 shows a flow chart of training and a flow chart of inference to determine a corruption type of an input image and use it to perform a computer vision task, which forms part of the computer vision system of FIG. 2;

FIG. 8 shows a flow chart summarising the method from FIG. 7 used to predict a label of a corruption type and use it to perform a computer vision task;

FIG. 9 shows a flow chart summarising a method of training normalisation statistics of a computer vision model using minimal training, according to at least one embodiment;

FIG. 10 shows a flow chart summarising the method of FIG. 9;

FIG. 11 shows a flow chart summarising a method of performing test time adaptation to set normalisation statistics of a computer vision model, according to at least one embodiment;

FIG. 12 shows a flow chart summarising the method of FIG. 11;

FIG. 13 shows a method of performing a computer visions task, namely object detection, using the RVC of FIG. 1;

FIG. 14 shows a method of performing a computer vision task, namely object detection, using a device;

FIG. 15 shows a flow chart summarising a computer-implemented method of performing a computer vision task;

FIG. 16 shows a flow chart summarising a computer-implemented method of generating a codebook;

FIG. 17 shows a flow chart summarising a computer-implemented method of generating a codebook;

FIG. 18 shows a flow chart summarising a computer-implemented method of controlling a robot to move;

FIG. 19 shows a smart oven 600 according to at least one embodiment;

FIG. 20 shows a smart washing machine 700 according to at least one embodiment; and

FIG. 21 shows a smart fridge 800 according to at least one embodiment.

### BRIEF DESCRIPTION OF THE DRAWINGS

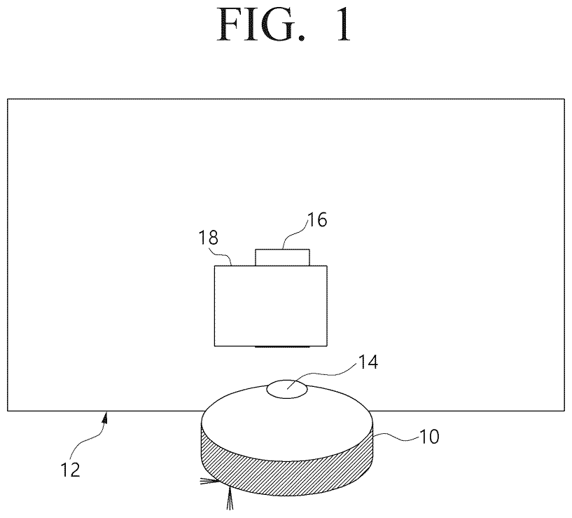

With reference to FIG. 1, a RVC 10 operates in a room 12. To navigate the room 12, the RVC 10 has at least one sensor 14, e.g. a camera. The RVC 10 also includes a computer vision system which performs at least one computer vision task, e.g. object detection, object recognition, semantic segmentation, etc. The RVC 10 also includes a trajectory planner and a control module respectively configured to generate a trajectory based on the results of the computer vision task(s) and control a driving system of the RVC 10 to move the RVC according to the trajectory.

The RVC 10 includes at least one processor and storage having instructions stored thereon that when executed by the at least one processor cause the at least one processor to perform methods such as capturing (or receiving or obtaining) a corrupted image using the camera, estimating (or identifying) a corruption type of the corrupted image using a corruption identification module, obtaining normalisation parameters associated with the estimated corruption type from a codebook, updating a computer vision model, trained to perform the task, by replacing normalisation parameters of the computer vision model with the obtained normalisation parameters, performing the task using the updated computer vision model, determining a trajectory based on a result of the computer vision task, and controlling the driving system to move the robot according to the trajectory.

The storage may be non-transitory computer readable media. When installing the instructions on the storage, the media may be transitory, i.e. a download signal.

In the room 12 of FIG. 1, the computer vision task may be to detect and recognise objects. For example, the computer vision task may be to recognise objects like a chair 16 and a table 18. The trajectory planner can then set a trajectory to avoid a collision with those recognised objects.

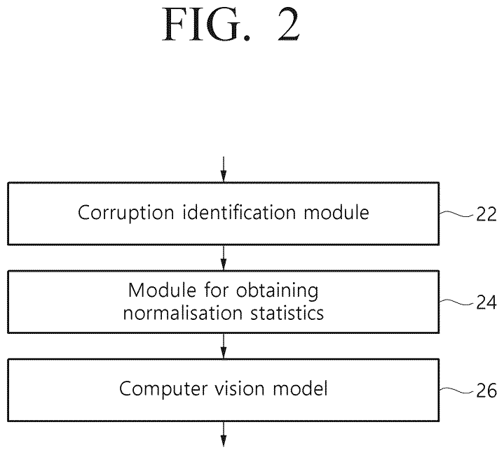

With reference to FIG. 2, the computer vision system 20 is represented as a flow chart showing its main components. The computer vision system 20 includes a corruption identification module 22, module for obtaining normalisation statistics 24, and a computer vision model 26.

As will be appreciated from the following description, the computer vision system 20 comprises the steps of receiving a corrupted image from the camera 14 (FIG. 1), estimating a corruption type of the corrupted image using the corruption identification model 22, obtaining normalisation parameters associated with the estimated corruption type, updating the computer vision model 26, trained to perform the task, by replacing normalisation parameters of the computer vision model with the obtained normalisation parameters, and performing the task using the updated computer vision model 26. The step of obtaining the normalisation parameters may be achieved using a code book.

There are two main embodiments involving the corruption identification model. In one embodiment, the corruption identification module includes a fast Fourier transform, FFT. In another embodiment, the corruption identification module 22 includes a machine learning model trained to estimate the corruption type using a corrupted image.

There are also two main embodiments involving updating the computer vision model 26. In one embodiment, a codebook has been generated by using minimal training to train only normalisation layers of the computer vision model for each corruption type. In another embodiment, a codebook has been generated by using test time adaptation where no labelled training data is available. Test time adaptation updates the normalisation statistics for the codebook. In either embodiment, at inference time, the codebook is used to identify the normalisation statistics associated with the identified corruption type.

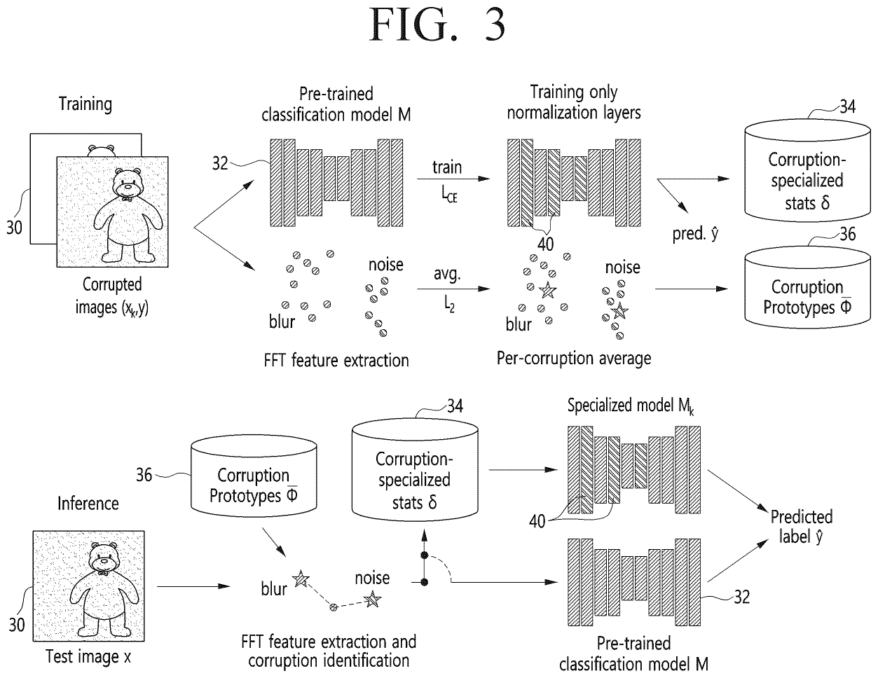

With reference to FIG. 3, an overall pipeline of a method, called the FFT-based RObust STatistics selection method, or FROST method for short, may be understood. The FROST method may be associated with the FFT embodiment described above. At training time, the following are constructed (i) corruption-specific prototypes using high-frequency FFT features and (ii) corruption-specific feature normalization statistics. At test time, FFT features are extracted and perform inference via prototype matching to select the most suitable statistics.

FROST performs a 2-step approach: At training time, FROST extracts high-frequency amplitudes from corrupted images, it aggregates them for images with the same corruption, and it builds a set of per-corruption feature prototypes. Then, it estimates corruption-specific (Corr-S), or corruption specialized 34, and corruption-generic (Corr-G) normalization layer parameters (normalisation statistics) 40 starting from a pretrained model 32. When the computer vision model is a neural network, and may be specifically a convolutional neural network, the normalisation layer paramters, or normalisation parameters may include at least one of batch normalisation, BatchNorm, statistics, and layer normalisation, LayerNorm, statistics. At test time, FROST identifies corruption types \hat{k} present in the test images and uses a codebook [symbol] to map such corruptions to normalization layers' parameters to minimize the recognition error. These normalization parameters [symbol] ′_{\hat{k}} come from either corruption-generic or specific model, depending on the confidence of the model.

Background. Given a computer vision model (or model) F, 32, that approximates ground truth labels y∈ [symbol] of samples x∈ [symbol] using a training set [symbol] ={ [symbol] , [symbol] }. In the current embodiment, a corrupted image is defined by \tilde{x}=x+ψ, where x∈ [symbol] ^{w×h×3} is a clean RGB image with the width w, height h and corruption ψ. The goal is to improve object recognition accuracy of M on the corrupted images.

Corruptions. Previous works showed that a real corruption ψ can be approximated by a combination of synthetic corruptions. A subset [symbol] ={Contrast, Brightness, Defocus Blur, Glass Blur, Motion Blur, Zoom Blur, Impulse Noise, Shot Noise, Gaussian Noise} is used of the 9 most common real corruptions. A synthetic corruption for the clean image x by C_{k,s}(x) is defined such that x+C_{k,s}(x)≈\tilde{x} for k∈ [symbol] (e.g., k=Contrast). The parameter λ∈{1,2,3,4,5} is an integer number which defines corruption intensity depending on the degradation level, with λ=1 being the lowest and λ=5 the highest.

Training. FFT features extraction. For each synthetic corruption in [symbol] , we construct a set [symbol] _{k,5}, by applying a corruption C_{k,5}(x) to all the images x∈↦. In this case, we use only the strongest corruption (s=5) to obtain a better separation between features for different corruptions. For each image \tilde{k}ₖ=x+C_{k,s}(x) with corruption k, we extract an FFT feature Φₖ=ℑₙ(\tilde{x}ₖ) by performing FFT ℑ(⋅) on the input image, applying windowing operation to retain the first n high-frequency components of the amplitude spectrum and flattening. In particular, n is selected empirically as n=15, computing ℑ(⋅) on images resized to 64×64. Then, we average each set of features specific to corruption k to obtain a corruption prototype, 36,

$${\overline{Φ}}_{k} = \frac{1}{N} {\sum }_{{\tilde{x}}_{k} ∈ {\tilde{𝒳}}_{k}} {Φ}_{k} , ∀ k ∈ 𝒦 ,$$

with N being the size of the training set. This can be done via a running average during training with no need to store all features into memory. We call this set Π̅. Analyzing the set of features [symbol] for different corruptions, we note that some results are very well clustered (e.g., Contrast, Brightness and Defocus Blur), while others (e.g., Blur types and Noise distortions) are hardly separable.

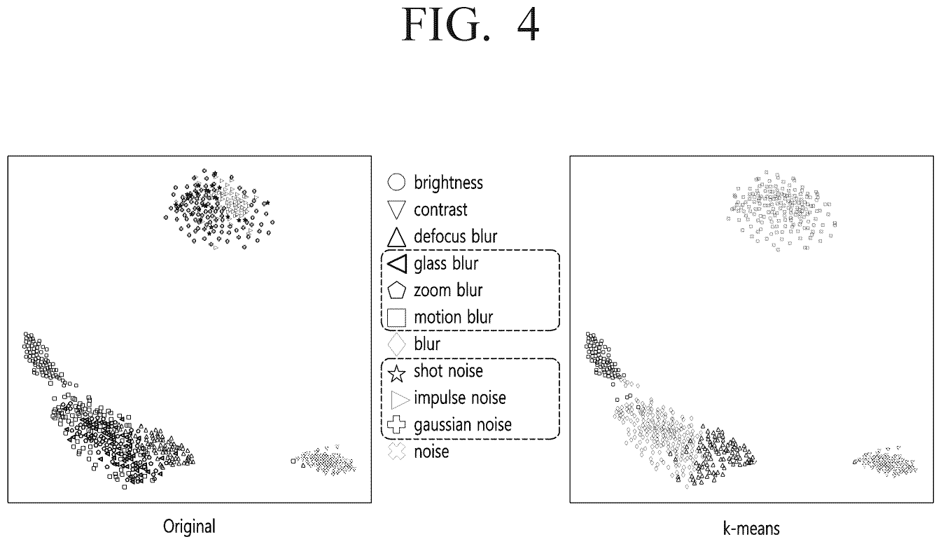

With reference to FIG. 4, to obtain a better clustering score, we compute k-means on the set [symbol] of FFT features. This set is originally labeled with corruption-relative labels L from [symbol] . Let us define a new labeling L* obtained through k-means. Setting empirically the number of clusters for the k-means to 5, we obtain similar clustering score as for original labels. In particular, if we group together Blur corruptions, and Noise corruptions, we obtain a new labeling L′. Comparing L* with L′ via quantitative analysis, we get an adjusted random score of 89.1% (meaning that the clusters are very similar). For this reason, we aggregate prototypes for features belonging to similar corruptions, obtaining a new set of corruptions [symbol] ′={Contrast, Brightness, Defocus, Blur, Noise} with 5 macro corruptions. Also, we obtain a new set of macro prototypes Π̅′ averaging prototypes with really close corruptions. Note that in real-world cases, high-frequency visual content could interfere with the corruption-related frequency content. In those cases, the algorithm can be extended adopting a multi-feature or a multi-scale FFT approach.

[I kept S (and not Λ because S=(γ, β, E[x], Var[x]), while Λ=(E[x], Var[x]))]

Estimation of corruption-specific statistics. We define by S the set of statistics estimated at all normalization layers (Batch/Layer Normalization) in the recognition model F. These layers are storage-friendly as they have only two parameters (scale γ and shift β) that have shown to adapt differently to input images affected by different corruptions. Therefore, our purpose is to use it to improve recognition accuracy for corrupted images. First, we train a model F (updating only normalization layers with S parameters) on [symbol] performing data augmentation ( [symbol] ) on clean samples by adding C_{k,s}(⋅). Image augmentations are selected according to a uniform distribution using original corruption functions for augmentations (K=9 in total) with severe corruptions only, i.e., s˜{4,5}. With this training, we obtain corruption-generic normalization statistics [symbol] . Then, we trainF (updating only normalization layers with S parameters) on [symbol] _{k,{4,5}} (i.e., [symbol] corrupted with corruption k, only usings ˜{4,5}), producing K different corruption-specific sets of normalization statistics Sₖ. According to macro corruption grouping [symbol] ′, we average normalization statistics for indistinguishable corruptions obtaining S′ₖ sets, one for each macro corruption.

Inference. At test time, we use prototypical features Π̅′ as keys of a codebook [symbol] to select the best set S*.

Prototype matching. We perform inference on each test image \tilde{x}ᵤ with unknown corruption u. First, we extract feature Φᵤ=ℑₙ(\tilde{x}ᵤ), retaining the first n high-frequency components of the FFT amplitude spectrum. Then, we compute the probability that image is corrupted with corruption k such that p(u=k)= [symbol] (Φᵤ, Φ̅ₖ) for each corruption k∈ [symbol] ′ using L2distance. Note that a test image can also be non-corrupted; we will explain how this case is handled in the next paragraph.

This may be expressed as, wherein the corruption identification module includes a fast Fourier transform, FFT, model, and wherein estimating the corruption type of the corrupted image using a corruption identification module comprises: extracting (or obtaining) features from the corrupted image; retaining (or maintaining) only features occurring with a frequency above a frequency threshold using the FFT model; determining a probability that the image in input is affected by a corruption type associated with the retained features is a corruption type based on a distribution of distances between the retained features and precomputed prototypical features of a known set of corruption types; and estimating the corruption type by selecting the corruption type with the highest probability. The distribution of distances is a distribution of Euclidian, L2, distances.

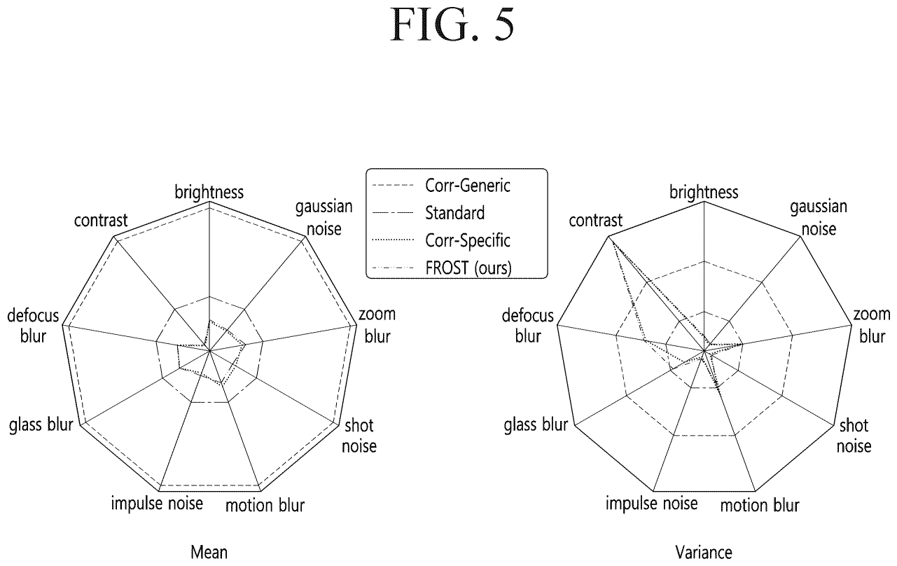

Selection of statistics. We use probability scores in order to select the most suitable set of normalization statistics S* via our codebook [symbol] , and apply it on top of the model F to enhance object recognition capabilities. First, we determine whether the corruption is uncertain, by applying a thresholding operation on the first two most likely corruptions. We define \hat{k}₁ and \hat{k}₂ as the most likely and second most likely estimated corruptions. If |p(u=\hat{k}₁)−p(u=\hat{k}₂)|<T, then we use corruption-generic normalization statistics [symbol] . Otherwise, we use corruption-specific normalization statistics S′_{\hat{k}}_{₁}. In this case, T is selected empirically (comparing distance values). Note that clean images are generally mapped to [symbol] ; however they have intrinsic noise and sometimes using S′_{\hat{k}}_{₁}, can be beneficial. We remark that corruptions share the same normalization parameters in the standard pretrained model and in the Corr-G model [symbol] . Instead, each corruption has its own set of normalization layer parameters in the Corr-S model, and aggregation of the FROST macro corruptions provides a good approximation of it which is more convenient for corruption identification via FFT (see FIG. 5).

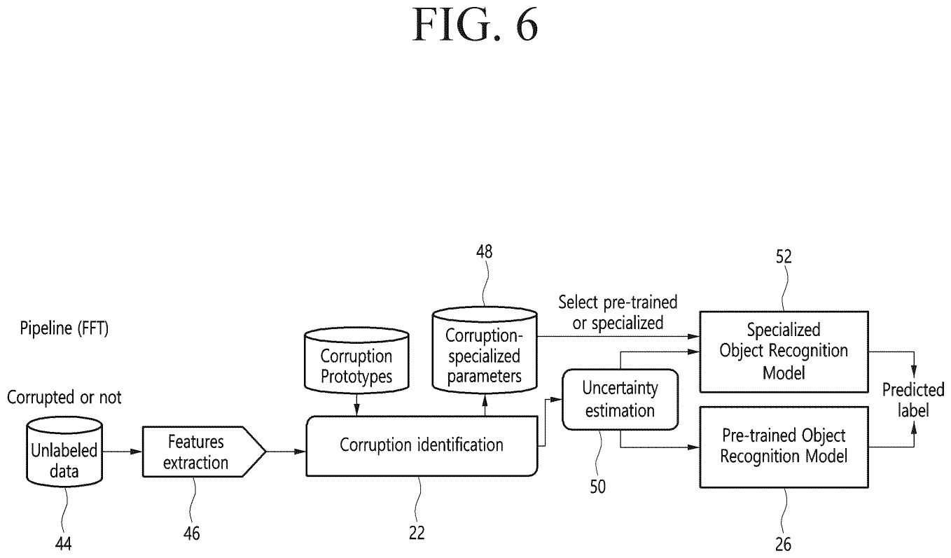

With reference to FIG. 6, at inference, the FFT method may be summarised as receiving unlabelled data (e.g. images) from an unlabelled storage 44, extracting features 46 using FFT as described above. Then, the corruption identification module 22 identifies the corruption type as described above. The normalisation statistics for the identified corruption type are retrieved from a corruption specialised parameters storage 48. The normalisation layers the pre-trained computer vision model 26 are replaced with the specialised parameters from the storage 48.

The corruption type is associated with a probability of being true. This probability is compared to a threshold probability as part of an uncertainty estimation 50. If the probability is lower than the threshold, the pre-trained computer vision model 26 may be used to perform the computer vision task, e.g. object recognition. If the probability is greater than or equal to the threshold, the updated computer vision model 52 is used for the computer vision task.

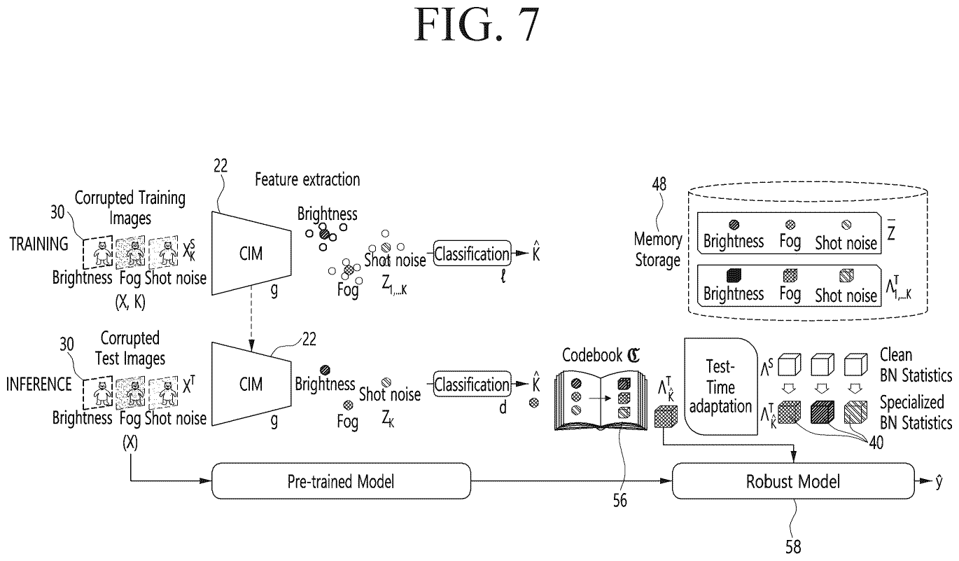

FIG. 7 relates to the other embodiment of the corruption identification model which has been trained to identify a corruption type from a corrupted image.

With reference to FIG. 7, the corruption identification module (CIM) build with a deep neural network 22 is trained on corrupted training images and a set of corruption-related prototypical features Z̅ is built, by averaging features z relative to each corruption. Then, at inference time, the CIM 22 is frozen and a Codebook [symbol] maps the corruption identified by the CIM 22 to the respective corruption-specific BN parameters. Such parameters are initialized with the ones of the pretrained downstream task model F(⋅) (computer vision model 32) on clean source images [symbol] and adapted to test images via TTA, separately for each identified corruption \hat{κ} (Sec. 3.3), obtaining a corruption-specific set [symbol] . Finally, [symbol] is plugged into F(⋅) to generate a robust model 58 achieving enhanced robustness on downstream tasks, specifically on the identified corruption.

This approach builds upon the observation that statistics of BN layers in any convolutional architecture significantly differ for images corrupted according to different corruption types, but are similar for images with the same corruption type. Some previous work explored adaptation of statistics of normalization layers for TTA, keeping a single set of normalization parameters for all corruptions, to build generic normalization layers to accommodate any input corruption. Instead, we build multiple sets of normalization statistics estimated for each corruption type. Per-corruption Adaptive Normalization (PAN) is composed of three parts:
1. A corruption type identification deep neural network module.
2. A per-corruption adaptation method for adapting statistics of BN layers to various corruption types at inference time.
3. A codebook 56 to map the identified corruption type to the respective set of BN statistics.

Image corruption: Let F(x, y; [symbol] ) be a DNN model mounted on a robot for visual scene understanding. The aim of F(⋅) is to approximate ground truth labels y∈ [symbol] of input images x∈↦⊂ [symbol] ^{w×h×3} optimizing its set of learnable parameters [symbol] (e.g., weights and biases of the network architecture of the model). Among these parameters, we denote the set of parameters of its BN layers by Λ⊂ [symbol] . Samples of a source (clean) dataset [symbol] ={ [symbol] } are drawn from a probability distribution [symbol] (x) on a source domain [symbol] . Then, we consider a target (corrupted) dataset [symbol] ={ [symbol] } of distorted images sampled from a target domain [symbol] . We make a distinction between real (endogenous) and synthetic (exogenous) distortions as follows:

Endogenous distortions are natural corruptions that imply a shift in image statistics due to either inherent noise of camera sensors, deformations of objects observed in the images, or divergence of patterns of the objects. This is the most general case, where target test data [symbol] cannot be parametrized by any operator. We denote as [symbol] a corrupted set of images, presenting the same type of corruption (e.g., dark images, where κ denotes the corruption type). The distribution of the images in the corrupted set is different from that of the source images, that is, [symbol] (x)≠ [symbol] (x).

Exogenous distortions are synthetic approximations of real corruptions provided by a function of clean images. They are obtained assuming that there exists an operator C_{k,s} which corrupts a given set of clean images [symbol] by C_{k,s}( [symbol] )= [symbol] . Synthetic corruptions represent an approximation of real corruptions, i.e., [symbol] ≈ [symbol] , where k∈ [symbol] denotes the corruption type and s denotes the level of severity of the corruption. Images of each corrupted set [symbol] are sampled from [symbol] (X)=ψ_{k,s}( [symbol] (x)) as the operator C_{k,s} transforms the distribution by a non-linear transformation ψ_{k,s} according to the corresponding corruption type k and severity s.

The CIM 22 is designed using a convolutional encoder followed by a linear classifier.

Architecture of the CIM. Extraction of corruption-specific features is accomplished through a DNN model r=l∘g, composed of a convolutional encoder g(⋅) that projects an input image x to a feature vector by z=g(x), and a linear layer l(z) that outputs corruption identification probabilities.

Training: The CIM 22 performs a corruption classification task to recognize and approximate the corruption present in each input image. A CIM model is trained on a training set [symbol] _{K}U_{κ=1}^{K} [symbol] , where each [symbol] ={ [symbol] } is a dataset of images corrupted with some corruption κ (can be endogenous or exogenous, where k=κ in case of exogenous) labelled with the corruption label [symbol] =κ denoting its distortion. [symbol] is the set of possible corruption labels which has cardinality | [symbol] |=K. The CIM model is trained end-to-end following via a distance-based contrastive training method utilizing a Class Anchor Clustering (CAC) loss defined by:

$${ℒ}_{CAC} ( x , y ) = {ℒ}_{T} ( x , y ) + λ {ℒ}_{A} ( x , y ) , \qquad ( 1 )$$

where x is the input image with its label y and λ is a hyperparameter.
   The CAC loss aggregates two individual losses: i) a tuplet loss [symbol] _{T}(x, y) used to minimize the distance between training samples and their ground-truth anchored class centre, and ii) an anchor loss [symbol] _{A}(x, y) used to maximize the distance to other anchored class centres. Thereby, the CAC loss [symbol] _{CAC} encourages training data to form tight and class-specific clusters, and anchored class centres to fix cluster centre positions during training.

Inference: After training the CIM model r(⋅) on [symbol] _{K}, the final layer l(⋅) is removed and the feature extractor g(⋅) is used to extract q-dimensional features z∈ [symbol] ^{q} from corrupted samples 1. Then, prototypical features

$${\overline{z}}_{κ} = \frac{1}{{h}_{κ}} {\sum }_{i = 0}^{{h}_{κ}} {z}_{i}$$

are computed from the training set, where each zᵢ is a feature vector corresponding to an image corrupted with corruption κ, and h_{κ} is the number of samples affected by the corruption κ. The calculated K prototypes are concatenated by Z̅=[z̅₁^{T}, z̅₂^{T}, . . . , z̅_{K}^{T}]^{T} to construct the prototype matrix Z̅∈ [symbol] ^{K×q} where (⋅)^{T} denotes the vector/matrix transpose.

We employ a distance-based classifier ϕ(⋅,⋅) to classify features according to their relative distance to prototypical features. The classifier ϕ(z, Z̅) outputs d=(∥z−z̅₁∥₂, . . . , ∥z−z̅_{K}∥₂)^{T} where ∥⋅∥₂ denotes the Euclidean norm.

The output is normalized by b=d⊙(1−soft min(d)), where ⊙ is the element-wise product, and

$${softmin ( d )}_{κ} = \frac{{exp}^{- {d}_{κ}}}{{\sum }_{κ = 1}^{K} {exp}^{- {d}_{κ}}} , d = {[ {d}_{κ} ]}_{κ = 1}^{K} , \qquad ( 2 )$$

is utilized to match the feature with the closest prototype. Then, the model r′=ϕ∘g predicts the corruption affecting the input by

$$\hat{κ} = arg {min}_{κ} ( b ) . \qquad ( 3 )$$

In this way, the CIM 22 includes a machine learning model (e.g. a deep neural network model) trained to estimate (or identify) a corruption type using a corrupted image. Estimating the corruption type of the corrupted image using the CIM 22 includes inputting the corrupted image to the machine learning model to estimate the corruption type from the corrupted image.

Batch Normalization (BN) is a technique, used to make training of artificial neural networks faster and more stable through normalization of the layer inputs by re-centering and re-scaling. It is widely used in DNNs to mitigate the problem of internal covariate shift, where changes in the distribution of the inputs of each layer affect the learning of the network. BN is applied over a 4D input (a mini-batch of 2D inputs with additional channel dimension).

Let [symbol] denote a mini-batch of features, obtained using model F(⋅), and let f∈ [symbol] ⊂ [symbol] ^{B×D×L} be a feature map in the mini-batch. The mean μ∈ [symbol] ^{D} and standard-deviation σ∈ [symbol] ^{D} (BN statistics) are employed per-dimension over the mini-batches channel-wise for normalizing features using

$$BN ( f ; μ , {σ}^{2} ) := γ \frac{f - μ}{\sqrt{{σ}^{2} + ϵ}} + β , \qquad ( 4 )$$

where γ and β are learnable affine parameter vectors of size D, and ϵ>0 is a small constant used for numerical stability.

Test-Time Adaptation (TTA) refers to adapting DNNs to distribution shifts, with access to only the unlabelled test samples belonging to the target domain [symbol] at test time. The conventional way of employing BN in test time is to set μ and σ² as those estimated from source data. Instead, TTA methods estimate BN statistics directly from test batches to reduce the distribution shift at test time by

$$μ = \frac{1}{BL} {\sum }_{f ∈ ℬ} f , {σ}^{2} = \frac{1}{BL} {\sum }_{f ∈ ℬ} {( f - μ )}^{2} . \qquad ( 5 )$$

This practice is simple yet effective and thus adopted in many recent TTA studies. In our paper, we propose updating BN statistics via TTA, separately, per each corruption type, as described next.

Estimating statistics on test data. Let Λ(μ, σ²)⊂ [symbol] be the set of BN statistics of the model F(x, y; [symbol] ). We denote the set of BN statistics obtained after training the model on the source dataset by [symbol] . We first initialize K sets of source BN parameters [symbol] . Then, we update each set according to the corruption type present in the input image. In the ideal case, each set is associated to a specific corruption type κ, and each corruption type is always identified correctly. Therefore, the BN statistics [symbol] associated with the type κ are updated only with images corrupted with corruption type κ that belong to the test set [symbol] . We define this ideal reference set of statistics by Λ_{κ}^{ref}. However, the target corrupted test images come without the corruption label κ, and BN parameters must be computed on the corruption type estimated by CIM (\hat{κ}).

When deployed on a robotic device, our system is composed of (i) a CIM module employed to recognise the corruption type affecting the unlabelled input test image, and (ii) K sets of clean BN statistics, obtained training a model F(⋅) on clean training data. The purpose of our PAN is to improve the downstream task performance of F(⋅) by using CIM to identify the correct corruption type, update the correct set of BN parameters via TTA, and finally plug the updated set of BN parameters into the network.

Codebook mapping. In detail, at inference time, for each input test image X∈ [symbol] , we estimate the corruption type using the CIM by r′(x)=\hat{κ}. Then, we use a codebook [symbol] to map each estimated corruption type \hat{κ} to a corruption-specific set of BN statistics [symbol] by

$$: \hat{κ} ↦ {Λ}_{\hat{κ}}^{𝒯} := ( {γ}_{\hat{κ}} , {β}_{\hat{κ}} ) . \qquad ( 6 )$$

Note that BN statistics associated with each of the K corruptions are initialized as [symbol] , and will be assigned to [symbol] after they are estimated by TTA. The more CIM is able to correctly recognize the corruption (when \hat{κ}=κ), the more the BN statistics are specialized for such corruption and are different from the others.

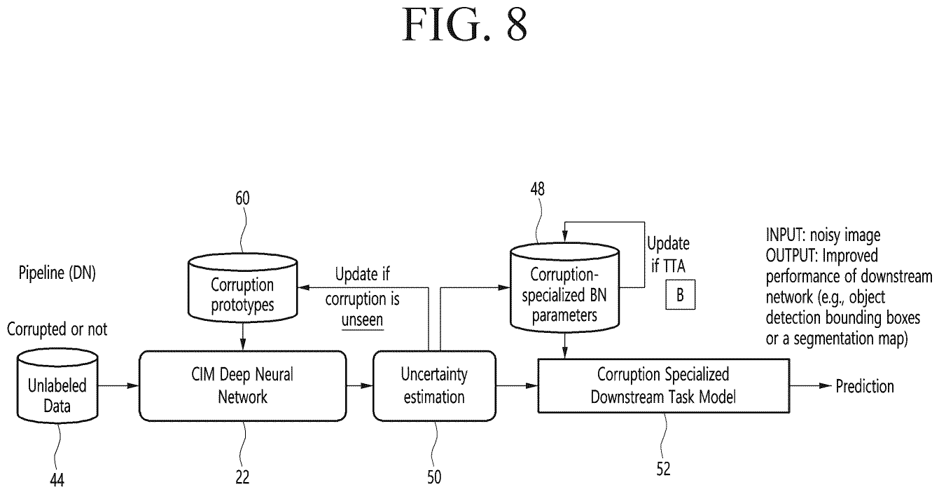

With reference to FIG. 8, at inference, the deep network method may be summarised as receiving unlabelled data (e.g. images) from an unlabelled storage 44. Then, the corruption identification model 22 identifies the corruption type as described above. The normalisation statistics for the identified corruption type are retrieved from a corruption specialised parameters storage 48. The normalisation layers of the pretrained computer vision model 26 are replaced with the specialised parameters from the storage 48.

The corruption type is associated with a probability of being true. This probability is compared to a threshold probability as part of an uncertainty estimation 50. If the probability of the most probable corruption type is lower than the threshold, the corruption type is labelled as unseen. The unseen corruption type is added to a corruption type storage 60. The corruption type with the highest probability is taken to be the corruption type and TTA may be used to update the normalisation parameters in the storage 48. The computer vision model is then updated to a specialised computer vision model 52. The specialised computer vision model includes the normalisation parameters from the storage 48 that are associated with the corruption type.

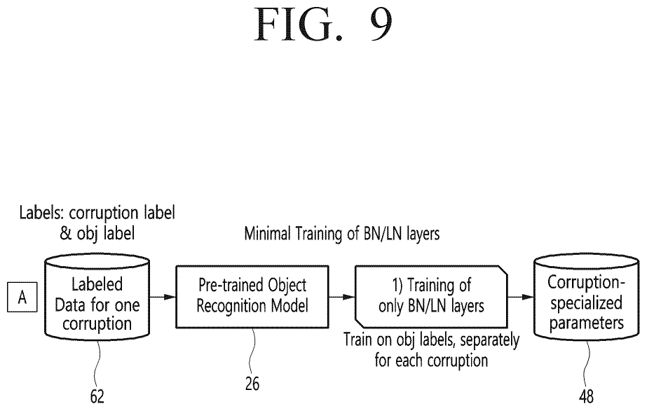

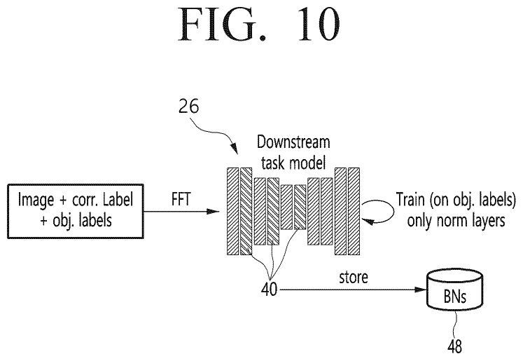

With reference to FIGS. 9 and 10, as described above, the method of training the normalisation layers of the pre-trained computer vision model includes retrieving from a storage 62 including corrupted image, corruption type labels and task result labels (e.g. object labels when the task is object detection). The method comprises providing the pre-trained computer vision model 26. Minimal training is performed on the pre-trained model 26 to train only the normalisation layers 40 using back propagation and an optimisation algorithm. To perform training, the task labels for one corruption type are used to optimise only the normalisation layers of the network. This is subsequently performed for all other corruption types. Then, the normalisation layers for each corruption type are stored in storage 48. The normalisation parameters in the storage 48 form the codebook.

In this way, the method shown in FIGS. 9 and 10 can be summarised as generating (or obtaining) a codebook by: providing a pretrained computer vision model and a training data set, wherein the training data set comprises, for each corruption type of a plurality of corruption types, a plurality of corrupted images and corresponding labels associated with the computervision task the model has been trained to perform; re-training the pretrained computer vision model, for each corruption type, using the plurality of corrupted images and corresponding labels by updating only normalisation layers of the pretrained computer vision model; and extracting the normalisation layers of the re-trained computer vision model for each corruption type; and generating (or obtaining) the code book to include the corruption type and corresponding normalisation layers.

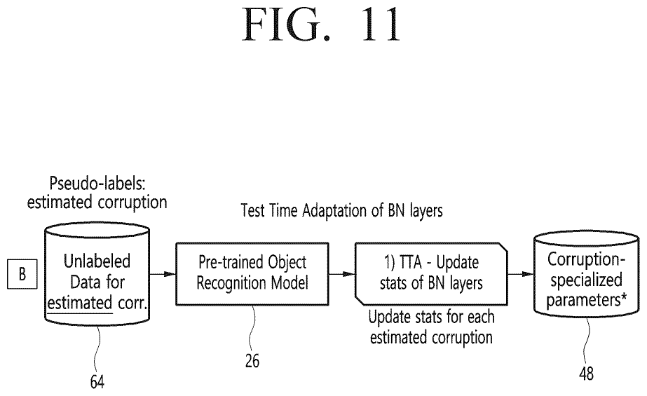

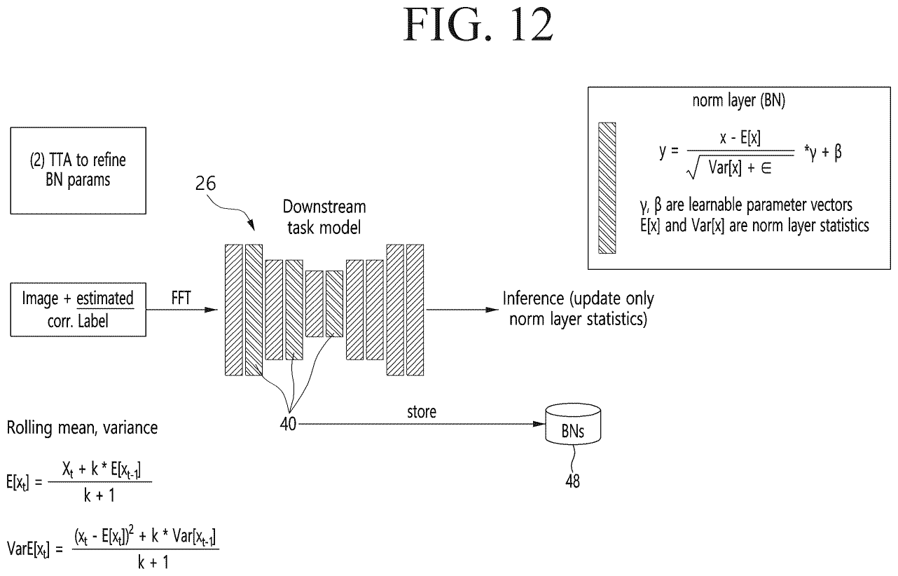

With reference to FIGS. 11 and 12, as described above, the method of setting normalisation statistics for a computer vision model using TTA includes retrieving estimated corruption labels from storage 64. The pre-trained computer vision model 26 is provided. TTA (as described above) is performed only on the normalisation layers 40 of the pre-trained model 26. The normalisation statistics (or parameters) are stored in the storage 48.

The normalisation statistics may include rolling mean and variance. The rolling mean, E[xt] may be updated using formula 7:

$$E [ {x}_{t} ] = \frac{{x}_{t} + n * E [ {x}_{t - 1} ]}{n + 1} \qquad ( 7 )$$

The variance, Var[xt] may be updated using formula 8:

$$Var [ {x}_{t} ] = \frac{{( {x}_{t} - E [ {x}_{t} ] )}^{2} + n * Var [ {x}_{t - 1} ]}{n + 1} \qquad ( 8 )$$

Here I would add also the update of features prototypes Z̅ (present in both, even if obtained with different CIMs):

$${\overline{Φ}}_{k} [ {x}_{t} ] = \frac{{Φ}_{k} + k * {\overline{Φ}}_{k} [ {x}_{t - 1} ]}{k + 1} ,$$

where Φ̅ₖ[xₜ] is the average prototypical feature for corruption type k, obtained after integrating image xₜ, Φₖ is the feature obtained using CIM on xₜ and Φ̅ₖ[xₜ₋₁] is the average prototypical feature for corruption type k before the update.

In this way, the method described in FIGS. 11 and 12 can be summarised as comprising: generating (or obtaining) a code book by: providing a pre-trained computer vision model, corrupted images, and corresponding corruption type labels estimated by the corruption identification model; updating normalisation layers of the pre-trained computer vision model based on the corrupted images and the corresponding corruption type labels using a test-time adaptation algorithm; extracting (or obtaining) the updated normalisation layers for each estimated corruption type; and generating (or obtaining) a code book to include the estimated corruption type and the corresponding normalisation layers.

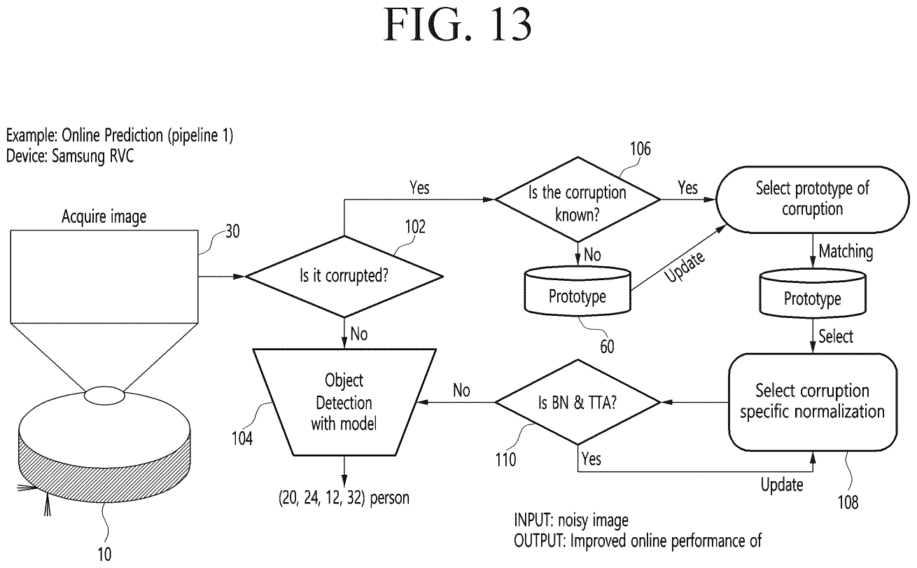

With reference to FIG. 13, a method of operating the RVC 10 may be summarised as including acquiring 100 an image 30, determining if the image is corrupted 102, if not, performing 104 a computer vision task such as object detection.

If the image is corrupted, it is assessed 106 whether the corruption type is known. If no, the corruption type is stored in storage 60. If yes, the corruption type is used to select 108 corresponding normalisation parameters. Next, it is determined 110 whether TTA is needed. If so, the normalisation statistics are updated as described above. If no, the object detection is performed 104.

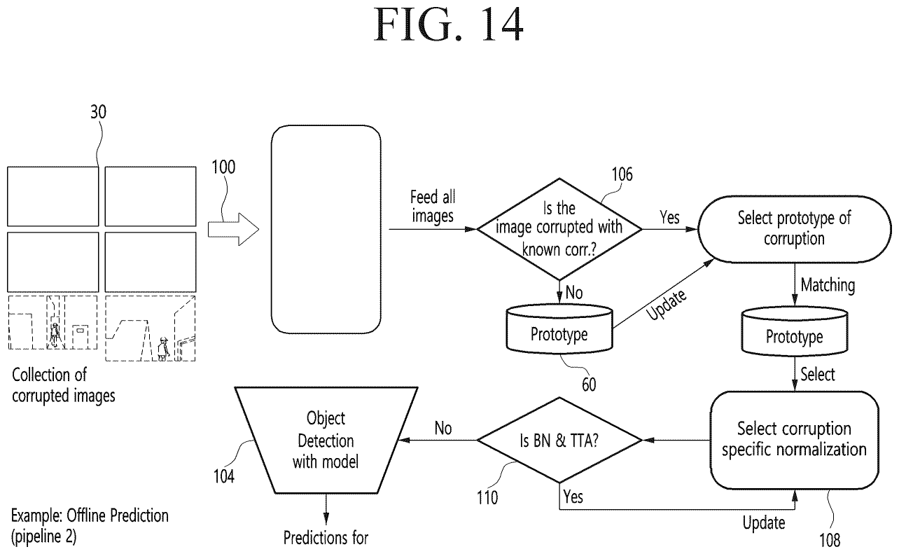

With reference to FIG. 14, another use case is summarised, this time a method of operating a user device, e.g. a smartphone 70. The method of operating the device 70 may be summarised as including acquiring a corrupted image 100. In this case, it is known that the image is corrupted so there is no step of determining if the image is corrupted. The corruption type is used to select 108 corresponding normalisation parameters. Next, it is determined 110 whether TTA is needed. If so, the normalisation statistics are updated as described above. If no, the object detection is performed 104.

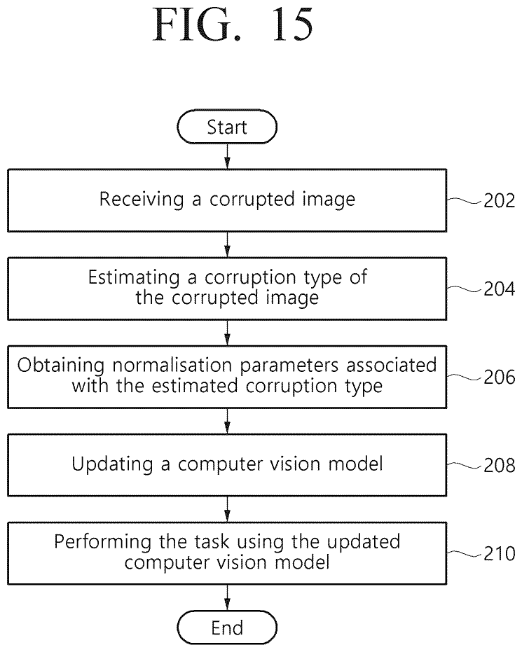

With reference to FIG. 15, a computer-implemented method of performing a computer vision task may be summarised as comprising: receiving 202 a corrupted image from a camera; estimating 204 a corruption type of the corrupted image using a corruption identification module; obtaining 206 normalisation parameters associated with the estimated corruption type; updating 208 a computer vision model, trained to perform the task, by replacing normalisation parameters of the computer vision model with the obtained normalisation parameters; and performing 210 the task using the updated computer vision model.

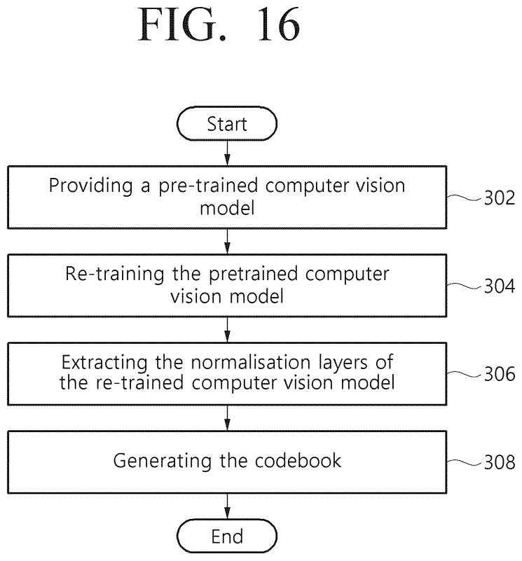

With reference to FIG. 16, a computer-implemented method of generating a codebook may be summarised as comprising: providing 302 a pre-trained computer vision model and a training data set, wherein the training data set comprises, for each corruption type of a plurality of corruption types, a plurality of corrupted images and corresponding labels associated with a computer-vision task the model has been trained to perform; re-training 304 the pretrained computer vision model, for each corruption type, using the plurality of corrupted images and corresponding labels by updating only normalisation layers of the pretrained computer vision model; and extracting 306 the normalisation layers of the re-trained computer vision model for each corruption type; and generating 308 the codebook to include the corruption type and corresponding normalisation layers.

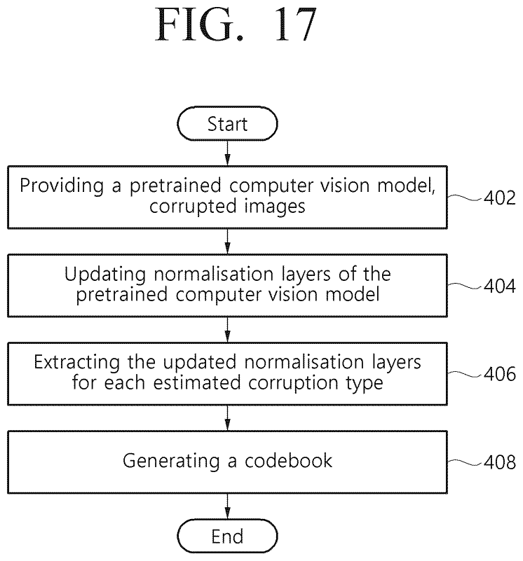

With reference to FIG. 17, a computer-implemented method of updating a codebook may be summarised as comprising: providing 402 a pretrained computer vision model, corrupted images, and corresponding corruption type labels estimated by the corruption identification module; updating 404 normalisation layers of the pretrained computer vision model based on the corrupted images and the corresponding corruption type labels using a test-time adaptation algorithm; extracting 406 the updated normalisation layers for each estimated corruption type; and generating 408 a codebook to include the estimated corruption type and the corresponding normalisation layers.

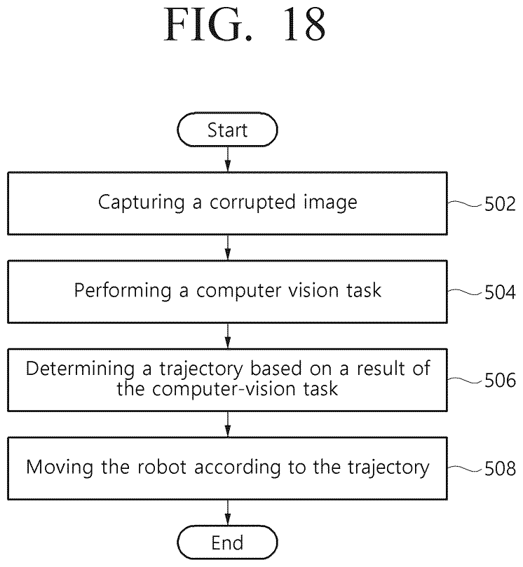

With reference to FIG. 18, a computer-implemented method of controlling a robot to move may be summarised as comprising: capturing 502 a corrupted image using a camera of the robot; performing 504 a computer vision task using the captured corrupted image; determining 506 a trajectory based on a result of the computer-vision task; and moving 508 the robot according to the trajectory.

Other applications of the foregoing methods are also envisaged.

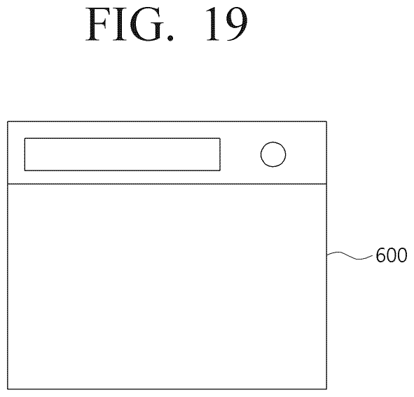

For example, with reference to FIG. 19, according to at least one embodiment, there is provided an oven 600. The oven may be a smart oven. The oven includes a processor and storage, similar to the other embodiments, e.g. the RVC. The oven 600 also includes a sensor such as a camera, e.g. an RGB camera. The processor may implement instructions on the storage to execute one or more computer-implemented methods including a method of recommending, and optionally, executing a cooking program. The cooking program may include a cooking duration, a cooking temperature that the oven will cook food for, and whether the oven will use a fan or no-fan. When the food is in the oven, the camera will capture an image of the food. The image is a corrupted image. The method will perform a computer vision task using the captured image. The computer-vision task may be object recognition, e.g. detecting what food is in the oven 600. The method will determine a cooking program based on a result of the computer-vision task, and may optionally run the cooking program by configuring the oven to cook the food according to the cooking program.

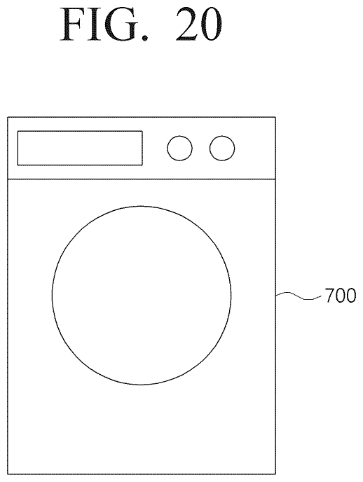

With reference to FIG. 20, according to at least one embodiment, there is provided a washing machine 700. The washing machine 700 may be a smart washing machine 700. The smart washing machine 700 includes a processor and storage, similar to the other embodiments, e.g. the RVC. The washing machine 700 also includes a sensor such as a camera, e.g. an RGB camera. The processor may implement instruction on the storage to execute one or more computer-implemented methods including a method of recommending, and optionally executing a washing program. The washing program may include a water temperature, a washing duration, spin cycle, etc. When the clothes are in the washing machine, the camera will capture an image of the clothes. The image is a corrupted image. The method will perform a computer vision task using the captured image. The computer-vision task may be object recognition, e.g. recognising clothes material/type, clothes colour, clothes dirtiness/cleanliness, etc. The method will determine a washing program based on the result of the computer-vision task, and may optionally run the washing program by configuring the washing machine 700 to wash the clothes according to the washing program.

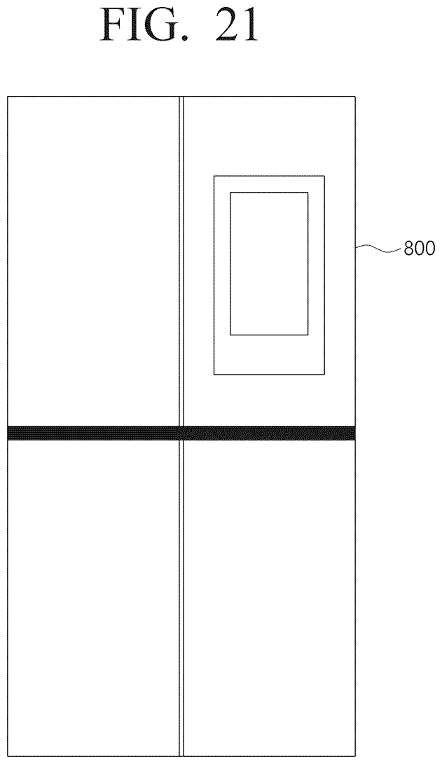

With reference to FIG. 21, according to at least one embodiment, there is provided a refrigerator, or fridge 800. The fridge 800 may be a smart fridge, The smart fridge 800 includes a processor and storage, similar to other embodiments, e.g. the RVC.

The smart fridge 800 also includes a sensor such as a camera, e.g. an RGB camera. The processor may implement instructions on the storage to execute one or more computer-implemented methods including a method of recommending a shopping list, list available items, or recipes that can be cooked with the available items. When items are added to the fridge, the method comprises the camera capturing an image of the items. The image is a corrupted image. The method will perform a computer vision task using the captured image. The computer-vision task may be object recognition, e.g. recognising food, or items, entering and being removed from the fridge. The method will determine the shopping list, list available items, or recipes that can be cooked with the available items.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

What is claimed is:

1. A method for controlling an electronic apparatus for performing a computer vision task, the method comprising:
receiving a corrupted image from a camera;
identifying a corruption type of the corrupted image using a corruption identification module;
obtaining normalisation parameters associated with the identified corruption type from a codebook;
updating a computer vision model, trained to perform the task, by replacing normalisation parameters of the computer vision model with the obtained normalisation parameters; and
performing the computer vision task using the updated computer vision model.

2. The method of claim 1,
wherein the corruption identification module includes a fast Fourier transform (FFT) model, and
wherein identifying the corruption type of the corrupted image using a corruption identification model comprises:
extracting features from the corrupted image,
retaining only features occurring with a frequency above a frequency threshold using the FFT model,
determining a probability that the image in input is affected by a corruption type associated with the retained features, which is a corruption type based on a distribution of distances between the retained features and pretrained prototypical features of a known set of corruption types, and
identifying the corruption type by selecting the corruption type with the highest probability.

3. The method of claim 2, wherein the distribution of distances is a distribution of Euclidian, L2, distances.

4. The method of claim 1,
wherein the corruption identification module includes a machine learning model trained to estimate a corruption type using a corrupted image, and
wherein identifying the corruption type of the corrupted image using a corruption identification module comprises:
inputting the corrupted image to the machine learning model to estimate the corruption type from the corrupted image.

5. The method of claim 4, wherein the machine learning model is a deep neural network model.

6. The method of claim 1,
wherein the computer vision model is a neural network model, and
wherein the normalisation parameters include at least one of batch normalisation, BatchNorm, parameters or layer normalisation, LayerNorm, parameters.

7. The method of claim 6, wherein the neural network model is a convolutional neural network model.

8. The method of claim 1, wherein the computer vision task is a computer vision task selected from a list of computer vision tasks including object detection, object recognition, semantic segmentation.

9. The method of claim 1, further comprising:
generating the codebook by:
providing a pre-trained computer vision model and a training data set, wherein the training data set comprises, for each corruption type of a plurality of corruption types, a plurality of corrupted images and corresponding labels associated with the computer vision task the model has been trained to perform,
re-training the pre-trained computer vision model, for each corruption type, using the plurality of corrupted images and corresponding labels by updating only normalisation layers of the pre-trained computer vision model,
extracting the normalisation layers of the re-trained computer vision model for each corruption type, and
generating the codebook to associate each recognizable corruption type to the corresponding normalisation layers parameters.

10. The method of claim 9, wherein the normalisation layers include at least one of batch normalisation, BatchNorm, layers and layer normalisation, LayerNorm, layers.

11. The method of claim 1, further comprising:
generating the codebook by:
providing a pre-trained computer vision model, corrupted images, and corresponding corruption type labels estimated by the corruption identification module,
updating normalisation layers of the pre-trained computer vision model based on the corrupted images and the corresponding corruption type labels using a test-time adaptation algorithm,
extracting the updated normalisation layers for each estimated corruption type, and
generating a codebook to associate each recognizable corruption type to the corresponding normalisation layers parameters.

12. An electronic apparatus for performing a computer vision task, comprising:
a memory; and
at least one processor connected the memory;
wherein the at least one processor configured to:
receive a corrupted image from a camera,
identify a corruption type of the corrupted image using a corruption identification module,
obtain normalisation parameters associated with the identified corruption type from a codebook,
update a computer vision model, trained to perform the task, by replacing normalisation parameters of the computer vision model with the obtained normalisation parameters, and
perform the computer vision task using the updated computer vision model.

13. The electronic apparatus of claim 12,
wherein the corruption identification module includes a fast Fourier transform (FFT) model, and
wherein the at least one processor configured to:
extract features from the corrupted image,
retain only features occurring with a frequency above a frequency threshold using the FFT model,
determine a probability that the image in input is affected by a corruption type associated with the retained features, which is a corruption type based on a distribution of distances between the retained features and pretrained prototypical features of a known set of corruption types, and
identify the corruption type by selecting the corruption type with the highest probability.

14. The electronic apparatus of claim 13, wherein the distribution of distances is a distribution of Euclidian, L2, distances.

15. The electronic apparatus of claim 12,
wherein the corruption identification module includes a machine learning model trained to estimate a corruption type using a corrupted image, and
wherein the at least one processor configured to:
input the corrupted image to the machine learning model to estimate the corruption type from the corrupted image.
